(19) United States
(12) Patent Application Publication
(10) Pub. No.: US 2024/0264299 A1
(43) Pub. Date: Aug. 8, 2024

(54) SENSING AIDED ORTHOGONAL TIME FREQUENCY SPACE (OTFS) CHANEL ESTIMATION FOR MASSIVE MULTIPLE-INPUT AND MULTIPLE-OUTPUT (MIMO) SYSTEMS

(71) Applicant: ARIZONA BOARD OF REGENTS ON BEHALF OF ARIZONA STATE UNIVERSITY, Scottsdale, AZ (US)

(72) Inventors: Ahmed ALKHATEEB, Chandler, AZ (US); Shuaifeng JIANG, Tempe, AZ (US)

(73) Assignee: ARIZONA BOARD OF REGENTS ON BEHALF OF ARIZONA STATE UNIVERSITY, Scottsdale, AZ (US)

(21) Appl. No.: 18/417,036

(22) Filed: Jan. 19, 2024

Related U.S. Application Data
(60) Provisional application No. 63/480,656, filed on Jan. 19, 2023.

(51) Int. Cl. G01S 13/58; G01S 7/35

(52) U.S. Cl. CPC G01S 13/584; G01S 7/354; G01S 7/356

(57) ABSTRACT

A computer system is disclosed that is configured to perform a method that includes receiving one or more radar data frames from one or more antennas of a base station or a user equipment device in an environment; processing the one or more radar data frames to identify one or more attributes of one or more static objects and one or more dynamic objects in the environment; and estimating one or more channels for the user equipment device and the base station based on the one or more attributes of the one or more static objects and the one or more dynamic objects.

### CROSS REFERENCE TO RELATED APPLICATION

This application claims priority to U.S. provisional patent application 63/480,656 filed on Jan. 19, 2023, the contents of which are hereby incorporated by reference in its entirety.

### FIELD OF THE DISCLOSURE

The present disclosure relates to sensing aided orthogonal time frequency space (OTFS) channel estimation for massive multiple-input and multiple-output (MIMO) systems.

### BACKGROUND

### I. Introduction

Orthogonal time frequency space (OTFS) modulation is a promising approach for achieving robust communication in highly-mobile scenarios. This is thanks to multiplexing the information bearing data into the nearly-constant channels in the delay-Doppler domain. Realizing these gains in massive MIMO systems, however, is challenging. This is mainly due to the high downlink pilot overhead which scales with the maximum delay spread and the maximum Doppler spread of the channel and with number of antennas at the transmitter. This motivates the development of novel approaches that enable the OTFS gains in massive MIMO systems, which is the objective of this paper.

For massive MIMO-OTFS systems, the channels typically experience 3D sparsity in the delay, Doppler, and angle dimensions. The channel sparsity in the delay dimension is due to the limited number of dominant propagation paths compared to the considered delay range while the sparsity in the Doppler dimension goes back to the small Doppler frequency of the dominant paths compared to the system bandwidth.

For the angle dimension, the channel sparsity is a result of the usually small angle of departure (AoD) spread for the propagation paths. Exploiting this channel sparsity in the three dimensions, prior work used different compressive sensing (CS) approaches to reduce the pilot overhead in estimating the OTFS massive MIMO channels. Despite its reduction, however, this channel acquisition overhead could still be significant for large-scale MIMO systems, especially in scenarios with large delay and Doppler spreads.

### SUMMARY

According to examples of the present disclosure, a method is disclosed that comprises receiving one or more radar data frames from one or more antennas of a base station or a user equipment device in an environment; processing the one or more radar data frames to identify one or more attributes of one or more static objects and/or one or more dynamic objects in the environment; and estimating one or more channels for the user equipment device and the base station based on the one or more attributes of the one or more static objects and the one or more dynamic objects.

Various additional features can be added to the method including one or more of the following features. The one or more attributes of the one or more static objects and the one or more dynamic objects comprise angle of arrival (AoA), angle of departure (AoD), delay, and Doppler velocity and the one or more attributes of the one or more channels comprise a power gain, a complex gain, delay, angle of arrival, and angle of departure of the one or more channels. The processing the one or more radar data frames comprises removing radar signals corresponding to the one or more static objects to yield one or more decluttered radar data frames. The method further comprises performing a first discrete Fourier transformation on the one or more decluttered radar data frames to extract range information corresponding to moving objects in the one or more decluttered radar data frames. The method further comprises performing a second discrete Fourier transformation on the one or more decluttered radar data frames to extract Doppler information corresponding to moving objects in the one or more decluttered radar data frames. The method further comprises performing a third discrete Fourier transformation on the one or more decluttered radar data frames to extract angle information corresponding to moving objects in the one or more decluttered radar data frames. The method further comprises generating a radar 3D-heatmap based on the range information, the Doppler information, and the angle information. The method further comprises determining one or more peaks in the 3D-heatmap. The method further comprises estimating a channel based on the one or more peaks in the 3D heatmap. The method further comprises extracting one or more radar paths based on the one or more peaks that were determined.

According to examples of the present disclosure, a computer system is disclosed that comprises a hardware processor and a non-volatile computer readable medium that stores instruction that when executed by the hardware processor perform a method comprising: receiving one or more radar data frames from one or more antennas of a base station or a user equipment device in an environment; processing the one or more radar data frames to identify one or more attributes of one or more static objects and one or more dynamic objects in the environment; and estimating one or more channels for the user equipment device and the base station based on the one or more attributes of the one or more static objects and the one or more dynamic objects.

Various additional features can be included in the computer system including one or more of the following features. The one or more attributes of the one or more static objects and the one or more dynamic objects comprise angle of arrival (AoA), angle of departure (AoD), delay, and Doppler velocity and the one or more attributes of the one or more channels comprise a power gain, a complex gain, delay, angle of arrival, and angle of departure of the one or more channels. The processing the one or more radar data frames comprises removing radar signals corresponding to the one or more static objects to yield one or more decluttered radar data frames. The method further comprises performing a first discrete Fourier transformation on the one or more decluttered radar data frames to extract range information corresponding to moving objects in the one or more decluttered radar data frames. The method further comprises performing a second discrete Fourier transformation on the one or more decluttered radar data frames to extract Doppler information corresponding to moving objects in the one or more decluttered radar data frames. The method further comprises performing a third discrete Fourier transformation on the one or more decluttered radar data frames to extract angle information corresponding to moving objects in the one or more decluttered radar data frames. The method further comprises generating a radar 3D-heatmap based on the range information, the Doppler information, and the angle information. The method further comprises determining one or more peaks in the 3D-heatmap. The method further comprises estimating a channel based on the one or more peaks in the 3D heatmap. The method further comprises extracting one or more radar paths based on the one or more peaks that were determined.

According to examples of the present disclosure, a method is disclosed that comprises receiving one or more radar data frames from an antenna of a base station or a user equipment device in an environment; processing the one or more radar data frames to remove radar signals corresponding to static objects to yield one or more decluttered radar data frames; performing a first discrete Fourier transformation on the one or more decluttered radar data frames to extract range information corresponding to moving objects in the one or more decluttered radar data frames; performing a second discrete Fourier transformation on the one or more decluttered radar data frames to extract Doppler information corresponding to moving objects in the one or more decluttered radar data frames; performing a third discrete Fourier transformation on the one or more decluttered radar data frames to extract angle information corresponding to moving objects in the one or more decluttered radar data frames; generating a radar 3D-heatmap based on the range information, the Doppler information, and the angle information; determining one or more peaks in the 3D-heatmap; and extracting one or more radar paths based on the one or more peaks that were determined.

According to examples of the present disclosure, a computer system is disclosed that comprises a hardware processor and a non-volatile computer readable medium that stores instruction that when executed by the hardware processor perform a method comprising: receiving one or more radar data frames from an antenna of a base station or a user equipment device in an environment; processing the one or more radar data frames to remove radar signals corresponding to static objects to yield one or more decluttered radar data frames; performing a first discrete Fourier transformation on the one or more decluttered radar data frames to extract range information corresponding to moving objects in the one or more decluttered radar data frames; performing a second discrete Fourier transformation on the one or more decluttered radar data frames to extract Doppler information corresponding to moving objects in the one or more decluttered radar data frames; performing a third discrete Fourier transformation on the one or more decluttered radar data frames to extract angle information corresponding to moving objects in the one or more decluttered radar data frames; generating a radar 3D-heatmap based on the range information, the Doppler information, and the angle information; determining one or more peaks in the 3D-heatmap; and extracting one or more radar paths based on the one or more peaks that were determined.

### BRIEF DESCRIPTION OF THE FIGURES

FIG. 1 shows an illustration of the adopted system model according to examples of the present disclosure. The BS exploits the radar sensing data to aid the MIMO-OTFS channel estimation.

FIG. 2 shows an illustration of the adopted signal models for both the communication and radar systems according to examples of the present disclosure.

FIG. 3 shows the adopted structure of the delay-Doppler frame with the data, pilot, and guard symbols according to examples of the present disclosure.

FIG. 4A, FIG. 4B, and FIG. 4C show examples of the propagation paths for the radar and the downlink communication systems according to examples of the present disclosure.

FIG. 5 shows the adopted radar processing according to examples of the present disclosure.

FIG. 6 shows the bird view of the adopted ray-tracing scenario according to examples of the present disclosure.

FIG. 7 shows the NMSE performance under different SNRs according to examples of the present disclosure. The number of BS antennas is 32 and the η (pilot overhead ratio) is 20%

FIG. 8 shows the NMSE performance with different η (pilot overhead ratio). The BS has 32 antennas. The SNR is set to 10 dB.

FIG. 9 illustrates a schematic view of a computing system according to examples of the present disclosure.

FIG. 10 shows a sparse channel recovery approach that is presented in Algorithm 1 according to examples of the present disclosure.

FIG. 11 shows Table 1 that lists the notation used in this disclosure.

FIG. 12 shows Table II that list the example system parameters used for the simulation described in this disclosure.

### DETAILED DESCRIPTION

Current wireless communication systems are not capable of reliably supporting highly-mobile applications such as augmented/virtual reality and autonomous vehicles/drones with high data rates. The orthogonal time-frequency-space (OTFS) modulation is a promising solution to address this problem. For systems with large numbers of antennas (which is the case in 5G and beyond), however, the signaling overhead associated with the operation of the OTFS systems becomes very high and greatly minimizes their promised gains. Accordingly, examples of the present disclosure provide for using sensing information or data (collected for examples by radar, LiDAR, camera, or position sensors) to reduce the critical signaling overhead in OTFS massive MIMO systems and to identify the propagation parameters of the highly-mobile users, which leads to significant reductions in the signaling overhead for these large antenna array systems.

Examples according to the present disclosure can significantly reduce the signaling overhead in OTFS massive MIMO systems (more than 50% reduction in the considered realistic scenarios). Since this signaling overhead is the main barrier for supporting highly-mobile applications, the developed technology has the potential to enable these highly-mobile applications such as augmented/virtual reality, autonomous vehicles/drones, and industry 4.0 navigating robots, in practice. Examples according to the present disclosure can be integrated in future 5G/6G, private networks, and WiFi communication systems to enable highly-mobile applications such as augmented/virtual reality, autonomous vehicles/drones, and industry 4.0 navigating robots.

Orthogonal time frequency space (OTFS) modulation has the potential to enable robust communications in highly mobile scenarios. Estimating the channels for OTFS systems, however, is associated with high pilot signaling overhead that scales with the maximum delay and Doppler spreads. This becomes particularly challenging for massive MIMO systems where the overhead also scales with the number of antennas. An observation however is that the delay, Doppler, and angle of departure/arrival information are directly related to the distance, velocity, and direction information of the mobile user and the various scatterers in the environment. With this motivation, radar sensing is leveraged to obtain this information about the mobile users and scatterers in the environment and leverage it to aid the OTFS channel estimation in massive MIMO systems.

According to examples of the present disclosure, OTFS channel estimation problem is used in massive MIMO systems as a sparse recovery problem and utilizes the radar sensing information to determine the support (locations of the non-zero delay-Doppler taps). The disclosed radar sensing aided sparse recovery algorithm is evaluated based on an accurate 3D raytracing framework with co-existing radar and communication data. The results show that the developed sensing-aided solution consistently outperforms the standard sparse recovery algorithms that do not leverage radar sensing data, highlighting a promising direction for OTFS massive MIMO systems.

Contribution: The delay-Doppler domain channel has a close and direct relation to the position, direction, and velocity of the mobile users and the various scatterers in the surrounding environment. Based on that, the radar sensing information is used about the users and the surrounding environment to aid the OTFS channel estimation in massive MIMO systems. This is further motivated by the potential integration and coordination of sensing and communications in future communication systems at which the sensing information could potentially be collected with negligible overhead on the wireless communication resources.

The contributions of the paper can be summarized as follows.

Proposing a novel approach that utilizes the radar sensing information at the base station (BS) to facilitate the massive MIMO OTFS channel estimation with significant reduction in the pilot overhead.

Developing a sensing framework that infers the delay, Doppler, and the AoD of the communication channel paths using information collected from the radar signals.

Designing an orthogonal matching pursuit (OMP) based algorithm that utilizes the extracted propagation delay, Doppler frequency, and AoD to improve the sparse OTFS channel recovery performance.

Developing a new simulation framework with co-existing wireless communication and radar sensing data and adopting it to evaluate the performance of the disclosed sensing-aided OTFS channel estimation approach.

Simulation results show that the disclosed sensing-aided OTFS channel estimation approach consistently outperforms the conventional sparse recovery algorithms. Specifically, the disclosed approach can achieve similar channel estimation NMSE performance with 5 dB lower SNR. Further, the disclosed approach can lead to more than 50% reduction in the pilot/channel acquisition overhead without any degradation in the channel estimation NMSE.

### II. System Model and Signal Model

In this section, the adopted system model is presented.

After that, the discrete-time signal model and the channel model for the considered MIMO-OTFS systems are discussed.

Lastly, the adopted radar signal model is presented.

### A. System Model

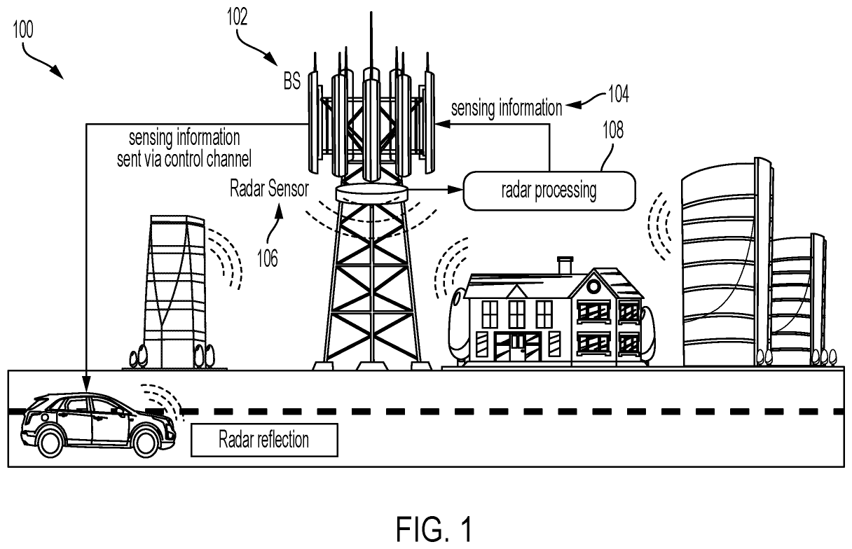

As shown in FIG. 1, a communication system 100 is considered where a BS 102 serves a single highly mobile UE using a carrier frequency f_{c}. The BS 102 employs a uniform linear array (ULA) of antennas to communicate with the UE. The BS is also equipped with an FMCW radar operating on the start frequency f₀. The FMCW radar collects sensing information 104 about the surrounding communication environment from radar processing 108 obtained from a radar sensor 106 that is coupled with the BS 102, which is then used to aid the downlink channel estimation. For simplicity, it is assumed that the UE is equipped with a single antenna. The disclosed sensing-aided OTFS channel estimation in this paper, however, can be extended to systems with the multi-antenna UEs.

### B. OTFS Communication Signal Model

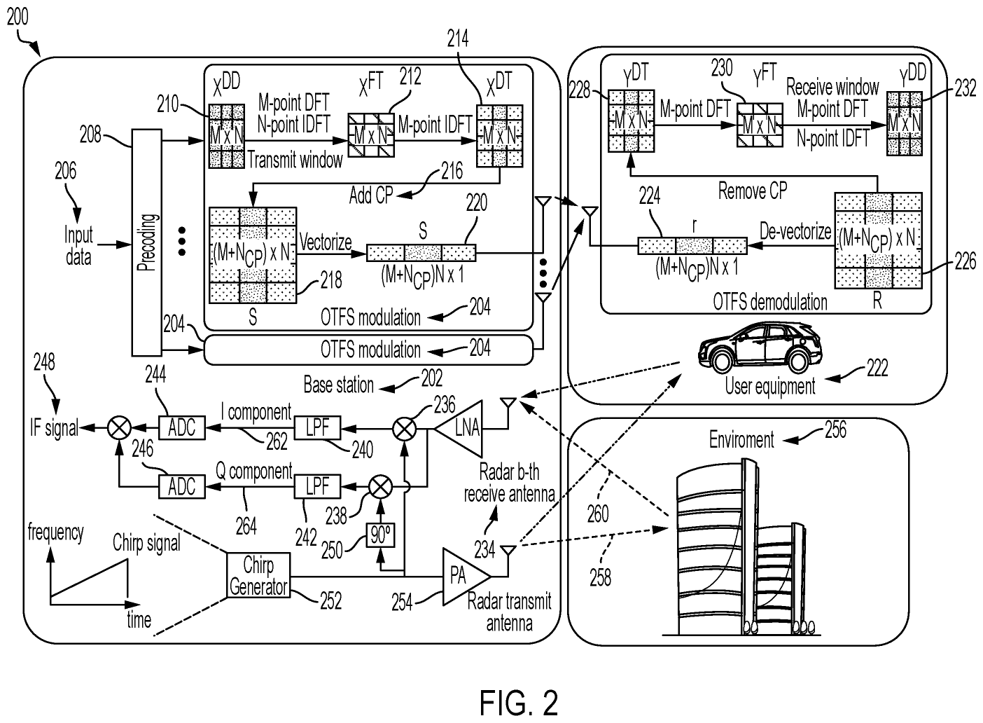

FIG. 2 shows an illustration of the adopted signal models for both the communication and radar systems according to examples of the present disclosure. For the downlink, the BS 202 applies OTFS modulation 204 to prepare the transmitted data. This OTFS modulation 204 is performed as follows. First, input data 206 is precoded by precoding 208 into M×N data symbols and are arranged into a two-dimensional OTFS frame X^{DD} ∈ [symbol] ^{M×N} 210 in the delay-Doppler domain. After that, the X^{DD} 210 is transformed into the time-frequency domain signal X^{FT} ∈ [symbol] ^{M×N} 212 as

$${X}^{F T} = {W}^{tx} ⊙ ( {F}_{M} {X}^{D D} {F}_{N}^{H} ) \qquad ( 1 )$$

where F_{M} and F_{N} denote the M-point and N-point discrete Fourier transformation (DFT) matrices, and W^{tx} is a windowing function¹. The operation ⊙ denotes the pointwise multiplication. It is assumed that the W^{tx} adopts rectangular windowing [9]. That is, W^{tx} is an all-one matrix and therefore can be omitted. The two-dimensional time-frequency domain signal X^{FT} 212 is then converted into a two-dimensional delay-time domain signal X^{DT} 214 as

$${X}^{D T} = {F}_{M}^{H} {X}^{F T} \qquad ( 2 )$$

With X^{DT}=[x₁, . . . , x_{N}], each column xᵢ can be regarded as a time-domain OFDM symbol of M subcarriers and X^{DT} comprises N consecutive OFDM symbols. To avoid inter-symbol interference, the cyclic prefix (CP) 216 is added to each OFDM symbol. ¹ In the general case where the delay/Doppler values don't belong exactly to the integer delay/Doppler bins, it becomes interesting to optimize the windowing matrix to suppress inter-Doppler-interference [8].

$$S = {A}_{CP} {X}^{D T} \qquad ( 3 )$$

where A_{CP} ∈ [symbol] ^{(M+N}^{_{CP}}^{)×M} is the CP addition matrix. Finally, the discrete-time time-domain baseband transmit signal can be obtained as

$$s = vec ( S ) \qquad ( 4 )$$

where s∈ [symbol] ^{(M+N}^{_{CP}}^{)N×1} 220 is the concatenation of all the columns in S 218 with vec(⋅) representing the vectorization operation.

1) OTFS demodulation: At the user 222, the discrete-time time-domain baseband receive signal can be denoted by r∈ [symbol] ^{(M+N}^{_{CP}}^{)N×1} 224. In OTFS demodulation, the r 224 is first rearranged into a two-dimensional signal R 226, which is given by

$$R = invec ( r ) \qquad ( 5 )$$

where invec(⋅) denotes the inverse operation of vec(⋅), i.e., A=invec(vec(A)). After that, the delay-time domain receive signal Y^{DT} 228 can be obtained by

$${Y}^{DT} = {R}_{CP} R \qquad ( 6 )$$

where R_{CP} ∈ [symbol] ^{M×(M+N}^{_{CP}}⁾ is the CP removal matrix. The time-frequency domain receive signal can then be written as

$${Y}^{FT} = {W}^{rx} ⊙ ( {F}_{M} {Y}^{DT} ) \qquad ( 7 )$$

where W^{rx} is a windowing matrix, and also the all-one matrix for W^{rx}. Finally, given Y^{FT} 230, the delay-Doppler receive signal Y^{DD} 232 is obtained by

$${Y}^{D D} = ( {F}_{M}^{H} {Y}^{F T} {F}_{N} ) \qquad ( 8 )$$

### C. OTFS Channel Model

A wide-band time-varying channel model is considered incorporating L propagation paths. Let αᵢ, τᵢ, νᵢ, and ψᵢ denote the complex gain, the delay, the Doppler frequency shift, and the angle of departure (AoD) associated with the i-th (i∈[1, . . . , L]) path, respectively. Let MΔf denote the bandwidth of the OTFS system, and NT denote the time duration of one OTFS frame. The delay tap index mᵢ and the Doppler tap index nᵢ corresponding to the i-th path can then be written as

$${m}_{i} = round ( M Δ f {τ}_{i} ) \qquad ( 9 a )$$

$${n}_{i} = round ( NT {υ}_{i} ) \qquad ( 9 b )$$

where round(⋅) denotes the rounding operation. Note that, for simplicity, this disclosure only considers the integer delay and Doppler cases, i.e., mᵢ ∈ [symbol] and nᵢ ∈ [symbol] . The discrete delay-time baseband channel of the a-th (a∈[1, . . . , A]) transmit antenna can then be written as

$$h [ m , q , a ] = {\sum }_{i = 1}^{L} {α}_{i} {z}^{{n}_{i} ( q - m )} {e}^{- j 2 π \frac{d}{λ} ( a - 1 ) {ψ}_{i}} sinc ( m - {m}_{i} ) \qquad ( 10 )$$

where m∈[0, . . . , M+N_{CP}−1] denotes the index of the delay tap, q∈[0, . . . , N(M+N_{CP})−1] denotes the index of the time tap, and

$$z = \frac{j 2 π}{N ( M + {N}_{CP} )} .$$

With this channel model, the receive signal at the user can be written as

$$r [ q ] = {\sum }_{a = 1}^{A} {\sum }_{m = 0}^{M - 1} h [ m , q , n ] {s}_{a} [ q - m ] + υ [ q ] \qquad ( 11 )$$

where r[q] denotes the q-th element in r∈ [symbol] ^{(M+N}^{_{CP}}^{)N×1}, and sₐ[q−m] denotes the (q−m)-th symbol transmitted by the a-th transmit antenna. The noise at the q-th time tap is denoted by ν[q].

OTFS Delay-Doppler Domain Channel Effect: Let Y_{m,n}^{DD} denote the element at the m-th row and the n-th column in Y^{DD}, and X_{m′m n′a}^{DD} denote the element at the m′-th row and the n′-th column in X^{DD} transmitted by the a-th antenna. Then, the input-output relation between the delay-Doppler domain signal X^{DD} in (1) and the Y^{DD} in (8) can be written as

$${Y}_{m , n}^{DD} = {\sum }_{a = 1}^{A} {\sum }_{{m}^{′} = 0}^{M - 1} {\sum }_{{n}^{′} = - N / 2}^{N / 2 - 1} {X}_{{m}^{′} , {n}^{′} , a}^{DD} {H}_{m - {m}^{′} , n - {n}^{′} , a}^{DD} {z}^{{l ( n - {n}^{′} )}_{N}} + {V}_{m , {n}^{′}}^{DD} \qquad ( 12 )$$

where V_{m,n}^{DD} is the noise in the delay-Doppler domain. Note that (n)_{N} denotes the modulo operation. The H_{m,n,a}^{DD} in (12) is the delay-Doppler domain channel coefficient corresponding to the m-th delay tap, n-th Doppler tap, and the a-th transmit antenna, which satisfies

$${H}_{m , n , a}^{DD} = {\sum }_{i = 1}^{L} {α}_{i} δ ( {m}_{i} - {( m )}_{M} , {n}_{i} - {( n )}_{N} ) {e}^{- j 2 π \frac{d}{λ} ( a - 1 ) {ψ}_{i}} \qquad ( 13 )$$

### D. Radar Signal Model

In the system model, the BS 202 is equipped with an FMCW radar. For simplicity, it is assumed that the radar has a single transmit antenna and B receive antennas. However, the radar signal model and processing can be generalized to MIMO radars. Since the sensing targets of interest are usually located away from the radar, it is assumed that they are in the far-field region of the radar.

The function of this radar is to obtain sensing information about the surrounding environment. In particular, the FMCW radar first emits chirp signals into the surrounding environment. These chirp signals interact with the surrounding objects and are reflected/scattered back to the radar. The received chirp signals are then processed to extract the sensing information. Mathematically, a transmitted radar chirp signal can be expressed as

$${s}_{chirp} ( t ) = \{ \begin{matrix}cos 2 π {f}_{0} t + π {St}^{2} \\ 0\end{matrix} if 0 \leq t \leq {T}_{c} , otherwise \qquad ( 14 )$$

where f₀, S, and T_{c} represent the start frequency, the slope, and the duration of the chirp signal, respectively. Note that the frequency of the chirp signal linearly increases from f₀ to f₀+ST_{c} during the transmission. The effective bandwidth of the chirp signal is given by B_{w}=ST_{c}.

To be able to obtain the Doppler/velocity information of the surrounding objects from environment 256, the radar typically transmits Nₗₒₒₚ identical chirp signals generated by chirp generator 252 and transmitted by radar transmit antenna 254. These identical chirp signals form a radar frame. The transmitted signal in one radar frame can then be written as

$${s}_{frame} ( t ) = {\sum }_{n = 0}^{{N}_{loop} - 1} {s}_{chirp} ( t - n {T}_{p} ) , 0 \leq t \leq {T}_{f} \qquad ( 15 )$$

where Tₚ denotes the chirp repetition time, and T_{f} denotes the radar frame duration. Note that T_{c}≤Tₚ is satisfied so that the chirp signals are non-overlapping. After the transmitted signal 258 is reflected/scattered back by objected in the environment 256 and captured by the receive antennas, such as radar b-th receive antenna 234, the received signal 260 at each antenna is mixed with the transmitted signal using a quadrature mixer 236, 238. The outputs of the quadrature mixer 236, 238 are the in-phase component 262 and the quadrature component 264. The in-phase component 262 and the quadrature component 264 are then passed through a low-pass filter (LPF) 240, 242, respectively, and analog-to-digital converters 244, 246, respectively, to obtain the so-called intermediate frequency (IF) signal 248. Assuming W ideal point reflectors to be the sensing targets, the IF signal corresponding to a single chirp at the b-th (b∈[1, . . . , B]) antenna can be written as

$${r}_{chirp}^{b} ( t ) \approx {\sum }_{w = 1}^{W} {β}_{w} exp ( j 2 π {f}_{0} {τ}_{w} - j π S {τ}_{w}^{2} ) exp ( j 2 π S {τ}_{w} t ) {e}^{- j 2 π \frac{{d}_{r}}{{λ}_{r}} ( b - 1 )} \\ \qquad ( 16 )$$

$$\approx {\sum }_{w = 1}^{W} {β}_{w} exp ( j 2 π {f}_{0} {τ}_{w} ) exp ( j 2 π S {τ}_{w} t ) {e}^{- j 2 π \frac{{d}_{r}}{{λ}_{r}} ( b - 1 )} \qquad ( 17 )$$

where dᵣ and λᵣ are the wavelength and the antenna spacing of the radar. The β is the complex gain that depends on the radar cross section (RCS), the transmit power, and the path-loss.

$${τ}_{w} = \frac{2 {D}_{w}}{c}$$

is the round-trip propagation delay with D_{w} denoting the propagation distance between the radar and w-th ideal point reflector. c represents the speed of light. In (16), the receive signals are neglected that have interacted with multiple sensing targets since they have smaller power. The approximation in (17) holds when S_{τ}<<f₀.

The receive signal at each antenna r_{chirp}^{b}(t) is then sampled by ADCs with the sampling rate of fₛ. Let Nₛ denote the number of complex ADC samples for each chirp. Note that each receive antenna has an independent receive chain including a quadrature mixer, low-pass filter, and ADCs. Finally, the ADC samples corresponding to Nₗₒₒₚ chirps and B receive antennas are collected to form a radar data frame denoted by X∈ [symbol] ^{N}^{ₛ}^{×N}^{ₗₒₒₚ}^{×B}.

### III. MIMO-OTFS Downlink Channel Estimation

Section II-B presented the OTFS signal model. Particularly, the delay-Doppler channel is given by (13), and the delay-Doppler domain input-output relation is given by (12). In this section, the adopted delay-Doppler domain OTFS frame structure is presented. After that, the formulation of the delay-Doppler domain channel estimation problem is introduced.

### A. OTFS Frame Structure

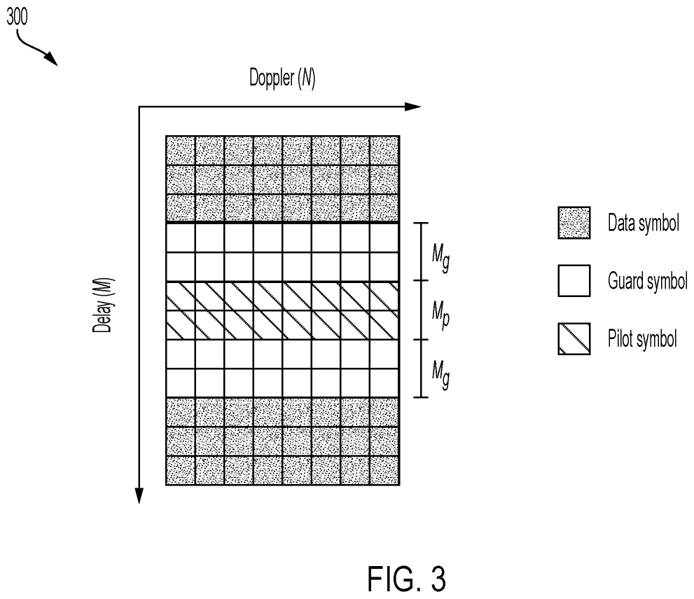

FIG. 3 shows the adopted structure 300 of the delay-Doppler frame with the data, pilot, and guard symbols according to examples of the present disclosure. The pilot and data symbols co-exist in the same OTFS frame. For simplicity, the data and pilot symbols are assumed to span across the entire Doppler dimension. The zero-power guard symbols are used to separate the pilot and data symbols along the delay dimension. The lengths of the pilot and guard symbols along the delay dimensions are Mₚ and M_{g} respectively. With Mₘₐₓ denoting the maximum delay spread, the length of the guard symbols along the delay dimension is assumed to satisfy M_{g}≥Mₘₐₓ. This way, the guard symbols can guarantee that the data symbols do not interfere with the pilot symbols. Note that all the transmit antennas transmit pilot signals on the pilot resources simultaneously. The pilot overhead of the adopted OTFS frame structure can be described by the pilot overhead ratio

$$η = \frac{{M}_{p}}{M} .$$

A good pilot design/channel estimation strategy can minimize the pilot overhead ratio.

### B. MIMO-OTFS Downlink Channel Estimation: A Compressive Sensing Formulation

Let x_{m,n,a} denote the training pilots in the delay-Doppler domain transmitted by the a-th antenna, where m∈[0, . . . , Mₚ−1] is the pilot index along the delay

$$n ∈ [ - \frac{N}{2} , … , \frac{N}{2} - 1 ]$$

is the pilot index along the Doppler dimension. Derived from (12), the received signal y_{m,n} can be written as

$${y}_{m , n} = {\sum }_{a = 1}^{A} {\sum }_{{m}^{′} = 0}^{{M}_{g} - 1} {\sum }_{{n}^{′} = - N / 2}^{N / 2 - 1} {z}^{{n ( m - {m}^{′} )}_{M}} {H}_{{m}^{′} , {n}^{′} a}^{DD} {x}_{{( m - {m}^{′} )}_{M} , {( n - {n}^{′} )}_{N , a}} + {v}_{m , n} \qquad ( 18 )$$

Next, the pilot symbols x_{m,n,a}, delay-Doppler channel coefficients H_{m,n,a}^{DD}, and received pilot y_{m,n} symbols are rearranged, and (18) is rewritten as a matrix-vector multiplication to form a sparse problem.

Let Z∈ [symbol] ^{M}^{ₚ}^{N×AM}^{_{g}}^{N} with the (mN+n+N/2+1, A(m′N+n′+N/2)+a)-th element being z^{n(m-m′)M}. Let P∈ [symbol] ^{M}^{ₚ}^{N×AM}^{_{g}}^{N} with the (mN+n+N/2+1, A(m′N+n′+N/2)+a)-th element being x_{(m-m′)}_{_{M′}}_{(n-n′)}_{_{N,a}}. Then (18) can be re-written as

$$y = ( Z ⊙ P ) h + v \qquad ( 19 )$$

where y∈ [symbol] ^{M}^{ₚ}^{N×1} with the (mN+n+N/2+1)-th element being y_{m,n}, and h∈ [symbol] ^{AM}^{_{g}}^{N×1} with the (A(m′N+n′+N/2)+a)-th element being H_{m′n′a}^{DD}.

Let Y=Z⊙P, then following [3], the sparse problem formulation is given by

$$y = Ψ h + v \qquad ( 20 )$$

Note that each element in h corresponds to a delay and Doppler tap in the delay-Doppler domain, and h is a sparse vector due to the sparsity of the delay-Doppler channel. According to [11], the number of dominant propagation path is limited (e.g., 6 paths). Therefore, the delay-Doppler channel is sparse in the delay dimension. The delay-Doppler channel is also sparse in the Doppler dimension since the Doppler frequency of a path is usually much smaller than the system bandwidth, and only the near-zero Doppler taps have relatively high power. Moreover, the transmit antenna domain can be further converted to the virtual angle domain to increase the sparsity of the h. Let A=I_{M}_{_{g}}_{N}⊗F_{A}, with ⊗ denoting the Kronecker product, and I denoting the identity matrix. The angle domain sparse problem formulation is then given by

$$y = Ψ \tilde{h} + v \qquad ( 21 )$$

where \tilde{Ψ}=ΨA^{H} and \tilde{h}=Ah. Utilizing the sparsity of the delay-Doppler domain channel [3], the MIMO-OTFS channel estimation can be achieved by solving (20) or (21) using conventional CS recovery algorithms such as basis pursuit and matching pursuit [13]. Next, the idea of using sensing to guide the OTFS-based MIMO channel estimation is discussed.

### IV. Sensing-Aided Delay-Doppler Channel Estimation

The convergence of communication, sensing, and localization is considered one of the features in 6G and beyond [14]. The sensing and localization capabilities may not just support new interesting applications such as AR/VR and autonomous driving, but also provide rich information and awareness about the surrounding environment to aid the communication systems. Furthermore, as will be explained in Section IV-A, this sensing information can be particularly meaningful and beneficial for delay-Doppler communication systems. To that end, the sensing capability at the BS is used to aid the MIMO-OTFS channel estimation problem.

In this section, the idea of sensing-aided delay-Doppler communications is introduced. After that, the relationship between communication and radar channels is discussed. Then, the adopted radar processing is explained to extract sensing information. Last, the disclosed sensing-aided channel estimation is discussed.

### A. Idea: Sensing-Aided Delay-Doppler Communications

The delay-Doppler domain channel has a close and direct relation to the direction/position of the UEs and the geometry of the surrounding environment. In particular, as shown in (13), each tap of the delay-Doppler domain channel corresponds to an existing propagation path of a certain delay and a certain Doppler frequency shift. This motivates utilizing the sensing capability to obtain prior information about the communication channel and improve delay-Doppler communications. For instance, using the sensing capability, the BS can obtain/estimate the relative position and velocity of the UE, and also the positions and shapes of the reflecting/scattering objects in the surrounding environment. With this sensing information, the BS can infer the potential propagation path parameters: the delay, the Doppler velocity, and the AoD/AoA. This prior knowledge of the propagation paths can help the delay-Doppler communications in several ways: (i) guiding or even bypassing channel estimation, (ii) improving channel feedback, and (iii) enabling proactive resource allocation.

According to examples of the present disclosure, the radar at the BS is used to obtain sensing information. Compared with other sensory options, radars have the following advantage. (i)

Recently, joint communication and radar systems have gained increasing interest [15], [16]. Being able to share the hardware and software resources with the communication systems can make the radar a more available and low-cost sensing solution.

(ii) Since the radar sensing signals are also transmitted through the wireless channel, the sensing information extracted from radars can have a closer and more straightforward relation to the wireless communication channels. (iii) Radar sensing can potentially obtain NLoS sensing information, which may not be available using other sensors.

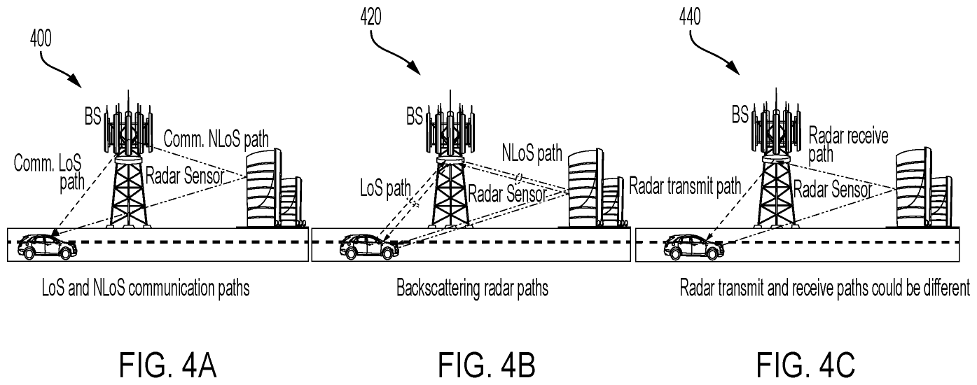

FIG. 4A, FIG. 4B, and FIG. 4C shows examples of the propagation paths 400, 420, 440, respectively, for the radar and the downlink communication systems according to examples of the present disclosure. The transmitted radar signals could be backscattered to the receiver through the same transmit paths or reflected and received from different directions.

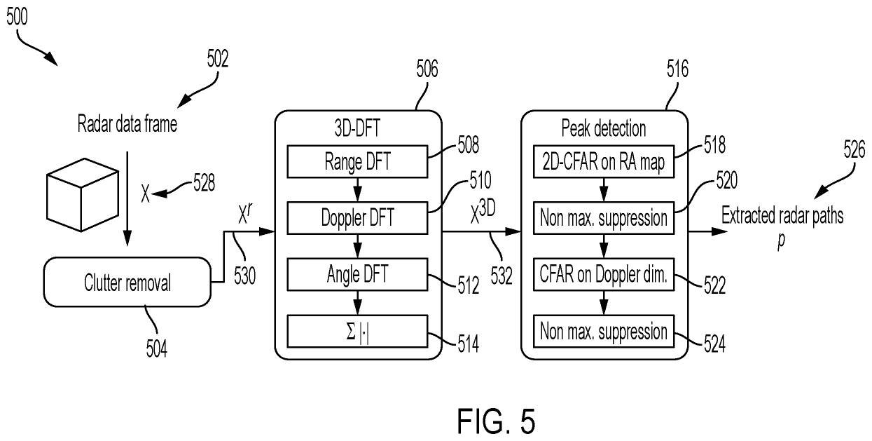

FIG. 5 shows the adopted radar processing 500 according to examples of the present disclosure. The radar data frame is processed through clutter removal, 3D-DFT, and peak detection to extract the radar propagation paths.

Next, the relationship between the communication channel and the radar channel is discussed.

### B. Relation Between Communication and Radar Channels

In FIG. 4A, FIG. 4B, and FIG. 4C, scenarios incorporating a BS, a UE, and a static reflector are shown. FIG. 4A shows the line-of sight (LoS) path and the non-line-of-sight (NLoS) paths of communication and radar channels. In FIG. 4B, two sets of radar propagation paths resulting from backscattering are presented. In this backscattering case, the radar propagation paths are closely related to the communication propagation paths shown by FIG. 4A in terms of the propagation delay, the Doppler velocity, and the AoD/AoA. Note that, the radar signal is likely to be reflected by other components of the UE instead of the UE antenna. Therefore, the communication paths in FIG. 4B does not align perfectly with the radar paths in FIG. 4A. However, when the distance between the BS and the UE is much greater than the size of the UE, the relation between the communication and radar paths can be approximated as follows.

The propagation delays and Doppler velocities of the radar paths are approximately twice of those of the corresponding communication paths.

The AoDs/AoAs of radar paths are approximately the same as the AoDs of the corresponding communication paths.

Apart from the backscattering cases shown in FIG. 4B, the radar transmit and receive propagation paths may be completely different. For instance, as shown in both FIG. 4(c), the radar transmit and receive signals propagate through the LoS and NLOS paths, respectively. As a result, the delay, the Doppler velocity, and the AoA/AOD of the radar propagation paths are not directly related to one communication path.

Although the radar propagation paths shown in FIG. 4C can lead to interference in the radar receive signals, they can be identified and filtered by exploiting the fact that the AoD and AoA are different. This can be potentially achieved when the radar has the transmit beamforming capability.

### C. Radar Processing

From the captured radar data frame X, the propagation delay, Doppler velocity, and angle of arrival (AoA) of the radar propagation paths corresponding to the UE are extracted.

FIG. 5 shows the disclosed radar processing 500 according to examples of the present disclosure.

Cutter removal: Since high-mobility scenarios are of interest, the clutter removal 504 is first applied to the radar data frame 502 X 528 to remove the radar signals corresponding to static objects. The clutter removal is mathematically given by

$${X}_{m , n , b}^{r} = {X}_{m , n , b} - \frac{1}{{N}_{loop}} {\sum }_{n = 1}^{{N}_{loop}} {X}_{m , n , b} \qquad ( 22 )$$

where X^{r} denotes the radar data frame after clutter removal. X_{m,n,b} and X_{m,n,b}^{r} index the elements from X 528 and X^{r} 530 according to the indices m, n, and b.

3D-DFT: After the clutter removal 504, three DFTs 506 are applied on X^{r} 530 to extract the range DFT 508, Doppler DFT 510, and angle DFT 512 information corresponding to the moving objects in the radar data frame.

Range DFT 508: the DFT is applied on the ADC samples dimension of X^{r} 530. This converts the chirp signal into the frequency domain. As can be observed from (17), the frequency of the received chirp signal is proportional to the propagation delay.

Doppler DFT 510: After the range DFT 508, the Doppler DFT 510 is applied along the second dimension of the X^{r} 530. The Doppler DFT 510 obtains the phase shift across the consecutive chirp signals. From these phase shifts, the Doppler velocity of the moving objects can be extracted.

Angle DFT 512: The angle DFT 512 operation is performed on the radar virtual antenna dimension, which extracts the angular information of the moving objects. Note that zero-paddings can be applied before the angle DFT 512 for more accurate angular estimation.

With DFT_{3D} 506 denoting the three DFT operations on the range DFT 508, Doppler DFT 510, and angle DFT 512 dimensions, the radar 3D-heatmap 532 can be obtained by

$${X}^{3 D} = \vert {DFT}_{3 D} ( {X}^{r} ) \vert \qquad ( 23 )$$

where the absolute operation is applied element-wise.

Peak detection 516: To detect the peaks in the 3D-heatmap X^{3D} 530, the constant rate false alarm rate (CFAR) algorithm can be used. Since the 3D-CFAR is computationally expensive, a 2D-CFAR 518 is first applied on the range-angle heatmap X^{RA}. The range-angle heatmap can be obtained by averaging the Doppler dimension of X^{3D} as shown by

$${X}_{m , b}^{RA} = \frac{1}{{N}_{loop}} {\sum }_{n = 1}^{{N}_{loop}} {X}_{m , n , b}^{3 D} \qquad ( 24 )$$

After that, a non-maximum suppression 520 is applied to the peaks detected by the 2D-CFAR to deal with the power leakage along the range and angle dimensions. Then, a 1D-CFAR 522 is applied on the Doppler dimensions of X^{3D} according to the peaks detected on the range-angle heatmap. The non-maximum suppression 524 is also employed after the 1D-CFAR.

After the peak detection 516, the propagation delay, Doppler velocity, and AoA of each peak is extracted and the radar paths 526 are then extracted. Let J denote the number of detected peaks from the radar peak detection, [symbol] ={(τ₁^{p}, ν₁^{p}, θ₁^{p}), . . . , (τⱼ^{p}, νⱼ^{p}, σⱼ^{p})}, where τₖ^{p}, νⱼ^{p}, σⱼ^{p} denote the propagation delay, Doppler velocity, and AoA of the j-th (j=[1, . . . , J]) peak, respectively, is obtained.

D. Sparse Recovery with Radar Sensing Information

To use the sensing information obtained from the radar to MIMO-OTFS channel estimation, each peak in [symbol] is converted to the index of angle domain OTFS channel \tilde{h} according to the propagation delay, Doppler velocity, and AoA of the peak. The propagation delay of the radar-detected propagation paths is normalized as follows:

$${\tilde{τ}}_{j}^{p} = \frac{{τ}_{j}^{p} - {min}_{j} {τ}_{j}^{p}}{2} \qquad ( 25 )$$

The above normalization is based on that the shortest radar propagation path can be detected as a peak in [symbol] . This is a reasonable assumption since the shortest propagation path is likely to be one of the strongest paths. To convert the Doppler velocity of each detected peak to Doppler frequency, the Doppler velocity is multiplied by the carrier frequency of the communication system as shown by

$${\tilde{v}}_{j}^{p} = \frac{{v}_{j}^{p}}{2} \cdot {f}_{c} \qquad ( 26 )$$

The normalized propagation delay \tilde{τ}ⱼ^{p} and Doppler frequency \tilde{ν}ⱼ^{p} are converted to delay tap and Doppler tap indices mⱼ^{p} and nⱼ^{p} of the communication channel using (9), respectively. The AoA θⱼ^{p} of the radar detected peaks are converted to the row indices fⱼ of F_{A} according to the beam steering angle of the row vectors in F_{A}. Mathematically, fⱼ is given by

$${f}_{j} = {argmax}_{{f}_{j}} {\vert {f}_{{f}_{j}} [ 1 , {e}^{- j 2 π \frac{d}{λ} cos {θ}_{j}^{p}} , … , {e}^{- j 2 π \frac{d}{λ} ( A - 1 ) cos {θ}_{j}^{p}} ] T \vert}^{2} \qquad ( 27 )$$

where f_{f} denotes the f-th row of F_{A}. Finally, the [symbol] is converted to set Sᵣ={t₁, . . . , tⱼ}, where tⱼ is the index of \tilde{h} corresponding to the j-th detected peak in [symbol] . tⱼ can be obtained by

$${t}_{j} = {f}_{j} + ( A - 1 ) {m}_{j}^{p} + ( A - 1 ) ( {M}_{g} - 1 ) ( {n}_{j}^{p} + \frac{N}{2} ) \qquad ( 28 )$$

After that, the Sᵣ is sent to the UE over the control channel. At the UE side, the radar extracted sensing information Sr is used to improve sparse channel recovery.

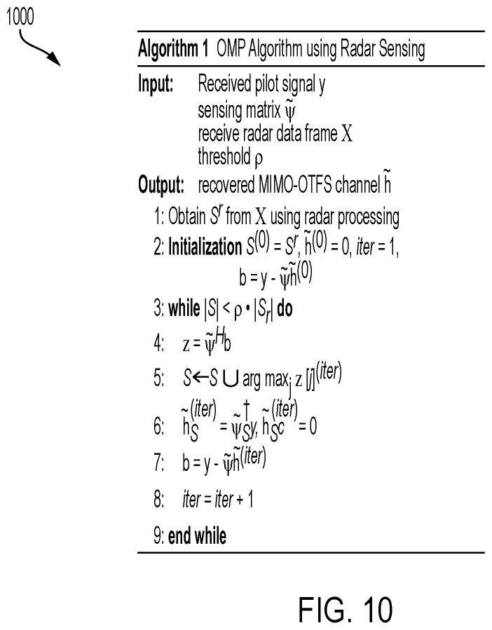

FIG. 10 shows a sparse channel recovery approach 1000 is presented in Algorithm 1 according to examples of the present disclosure. The sparse channel recovery approach 1000 iteratively updates the estimated support of the sparse signal by calculating the strongest correlations between the residual signal and the sensing matrix. After the last iteration, the sparse channel recovery approach 1000 applies the least square (LS) estimation on the elements in the sparse signal as indicated by the estimated support. In the sparse channel recovery approach 1000, the Sr is used to initialize the estimated support of the spare signal. The delay, Doppler, and AoAs taps extracted from the radar sensing information are expected to be similar to those of the communication channels. Also inn the sparse channel recovery approach 1000, the maximum number of iterations and the size of the estimated support adaptively are set according to the number of peaks detected in [symbol] , as shown by

$$\vert 𝒮 \vert \leq ρ \cdot \vert {𝒮}_{r} {𝒮}_{r} \vert \qquad ( 29 )$$

where ρ≥1 is a hyper-parameter. The intuition is that, when the UE is in a more complicated environment with many po incorporate more (resolvable) propagation paths. Meanwhile, the radar should also tend to detect more peaks/paths.

### V. Simulation Data Generation

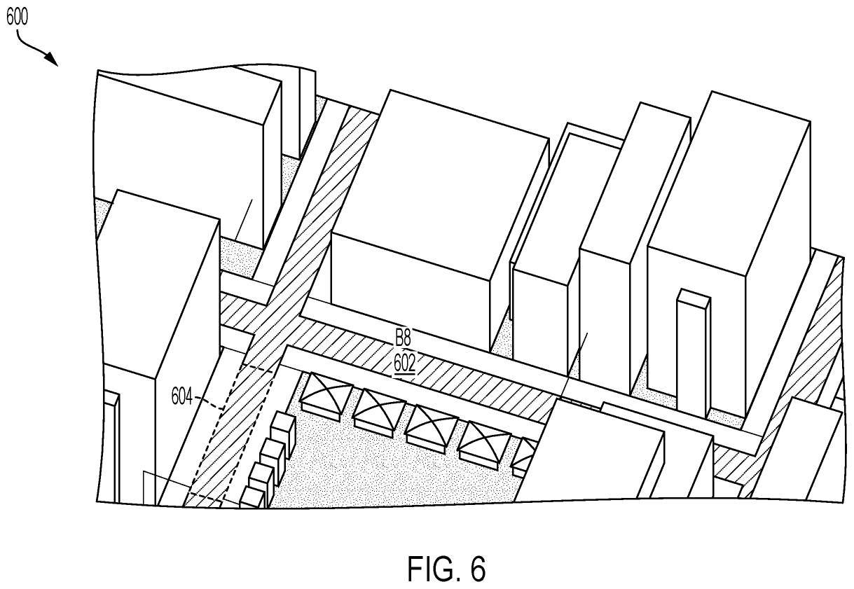

According to examples of the present disclosure, radar sensing capability at the BS is used to improve downlink channel estimation for MIMO-OTFS systems. Hence, realistic co-existing wireless communication and radar channel modeling is essential for the simulation. To that end, wireless communication and radar channels are generated based on accurate ray-tracing. FIG. 6 shows the bird view of the adopted ray-tracing scenario 600 according to examples of the present disclosure. The raytracing scenario models a downtown area. It comprises the intersections of one horizontal street and two vertical streets, and various buildings. The BS 602 is located on one side of the horizontal street and points to the other side of the street. The high-mobility UE is randomly distributed in the area noted by the box 604 with a random velocity uniformly sampled from [50, 90] m/s. For communication and radar channels, 6 GHZ and 28 GHz frequency bands, respectively, are adopted. The detailed simulation parameters are summarized in Table II. One hundred scenes are sampled with different UE locations and velocities.

For each scene, the communication and radar channel parameters are generated. Specifically, based on ray-tracing, the parameters of each propagation path including the complex gain, the propagation delay, the Doppler frequency, the AoA, and the AoD are simulated. From these channel parameters, the communication channel H_{m,n,a}^{DD}, and the radar data frame X are obtained.

### VI. Simulation Results

In this section, the performance of the disclosed sensing-aided channel estimation is compared with the conventional OMP in terms of the normalized mean square error (NMSE) and pilot overhead ratio.

### A. Does Sensing Improve Channel Estimation Accuracy?

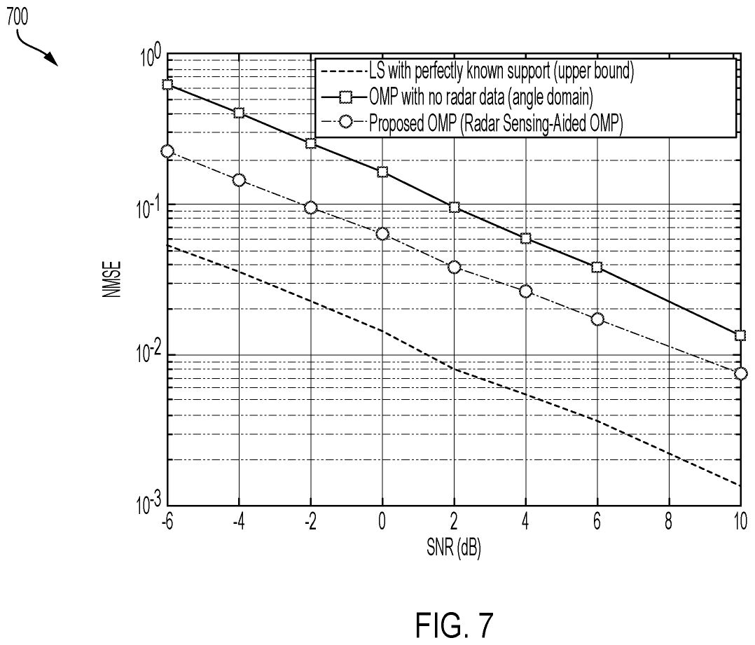

FIG. 7 shows a plot 700 of the NMSE performance is compared under the various SNR levels. The number of antennas is set to 32, the pilot overhead ratio n is 20%, i.e., 256×14×0.2≈716 symbols are allocated to the pilot signal. The genie-aided approach “LS on support” relies on perfect knowledge of the communication channel support to solve (20). That is, the support of h is assumed to be known, and LS is applied to recover the channel taps indicated by the support. The “OMP (angle domain)” do not exploit any prior channel support information. Instead, it directly applies the OMP algorithm to solve (21). The “OMP radar support (angle domain)” is the disclosed approach as shown in Algorithm 1.

It can be observed that the NMSE performance of all three methods improve as the SNR increases. The “LS on support” can achieve the best NMSE performance among the three methods. Since the “LS on support” is a genie-aided method that assumes perfect knowledge on the channel support, it can be considered the upper-bound method.

The disclosed approach outperforms the OMP (angle domain) in the SNR region shown in FIG. 7. In particular, the disclosed approach achieves similar NMSE performance with 5 dB lower SNR compared with the OMP (angle domain). The performance gap between the disclosed method and the OMP (angle domain) is slightly larger at the low SNR region. When the noise level is high, it is difficult for the OMP (angle domain) to find correct dominant channel taps. However, the disclosed method can leverage the channel support extracted from the radar signals.

### B. Does Sensing Reduce Pilot Overhead?

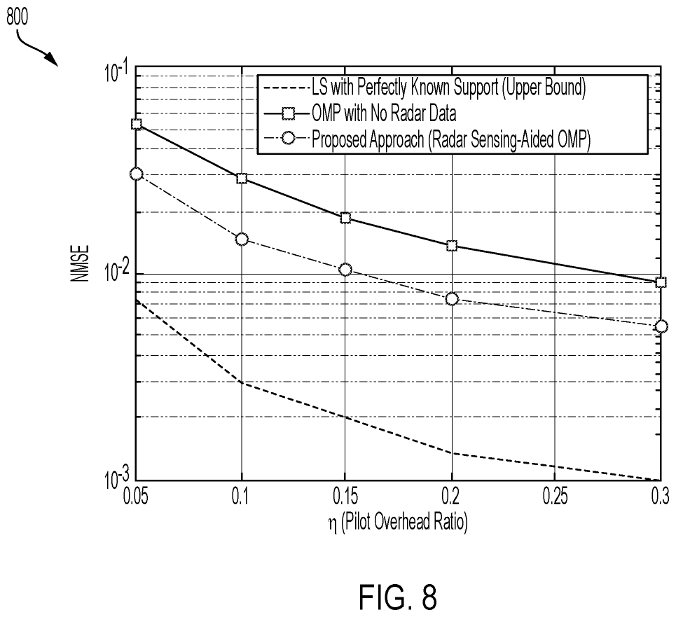

FIG. 8 shows a plot 800 of the NMSE performance comparison is presented under various pilot overhead ratio η. The SNR here is set to 10 dB. It can be observed that the NMSE decreases when more pilot signals are used for channel estimation, which is expected. The disclosed approach consistently outperforms the “OMP (angle domain)” with different pilot overhead.

Particularly, the disclosed approach achieves similar NMSE performance using n=0.15 compared to the “OMP (angle domain)” using n=0.3. This indicates a 50% decrease in the pilot overhead. This result implies the prospect of utilizing radar sensing to reduce channel estimation overhead.

Although the “LS on support” can achieve low NMSE with small pilot overhead, it requires perfect knowledge on the channel support, which is not practical. It can be seen that the performance gap between the “LS on support” and the disclosed method is relatively large, which leaves room for future improvements. It can be interesting to investigate more effective radar processing and channel estimation approaches to better utilize the radar sensing information.

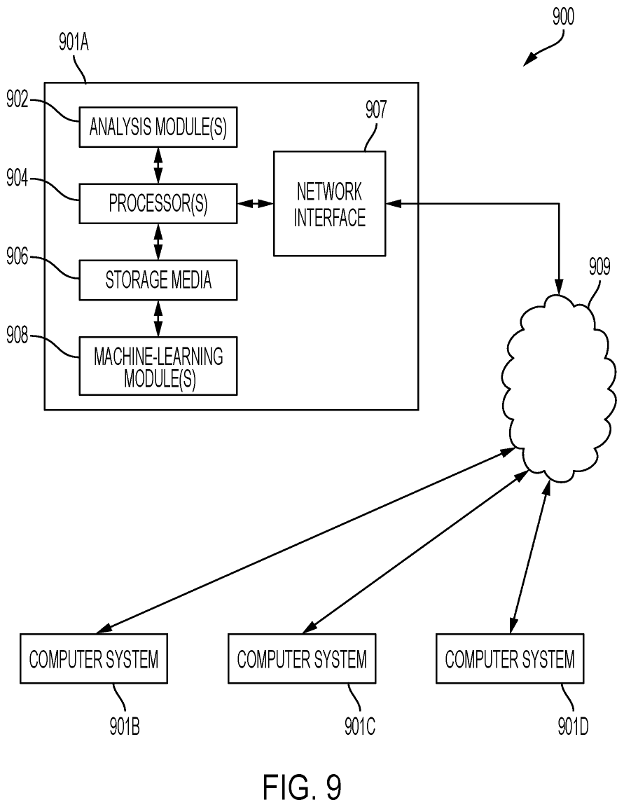

In some embodiments, any of the methods of the present disclosure may be executed by a computing system. FIG. 9 illustrates an example of such a computing system 900, in accordance with some embodiments. The computing system 900 may include a computer or computer system 901A, which may be an individual computer system 901A or an arrangement of distributed computer systems. The computer system 901A includes one or more analysis module(s) 902 configured to perform various tasks according to some embodiments, such as one or more methods disclosed herein. To perform these various tasks, the analysis module 902 executes independently, or in coordination with, one or more processors 904, which is (or are) connected to one or more storage media 906. The processor(s) 904 is (or are) also connected to a network interface 907 to allow the computer system 901A to communicate over a data network 909 with one or more additional computer systems and/or computing systems, such as 901B, 901C, and/or 901D (note that computer systems 901B, 901C and/or 901D may or may not share the same architecture as computer system 901A, and may be located in different physical locations, e.g., computer systems 901A and 901B may be located in a processing facility, while in communication with one or more computer systems such as 901C and/or 901D that are located in one or more data centers, and/or located in varying countries on different continents).

A processor can include a microprocessor, microcontroller, processor module or subsystem, programmable integrated circuit, programmable gate array, or another control or computing device.

The storage media 906 can be implemented as one or more computer-readable or machine-readable storage media. The storage media 906 can be connected to or coupled with a machine learning module(s) 908. Note that while in the example embodiment of FIG. 9 storage media 906 is depicted as within computer system 901A, in some embodiments, storage media 906 may be distributed within and/or across multiple internal and/or external enclosures of computing system 901A and/or additional computing systems. Storage media 906 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions or located at a remote site from which machine-readable instructions can be downloaded over a network for execution.

It should be appreciated that computing system 900 is only one example of a computing system, and that computing system 900 may have more or fewer components than shown, may combine additional components not depicted in the example embodiment of FIG. 9, and/or computing system 900 may have a different configuration or arrangement of the components depicted in FIG. 9. The various components shown in FIG. 9 may be implemented in hardware, software, or a combination of both hardware and software, including one or more signal processing and/or application specific integrated circuits.

Further, the steps in the processing methods described herein may be implemented by running one or more functional modules in an information processing apparatus such as general purpose processors or application specific chips, such as ASICs, FPGAS, PLDs, or other appropriate devices. These modules, combinations of these modules, and/or their combination with general hardware are all included within the scope of protection of the invention.

Models and/or other interpretation aids may be refined in an iterative fashion; this concept is applicable to embodiments of the present methods discussed herein. This can include use of feedback loops executed on an algorithmic basis, such as at a computing device (e.g., computing system 900, FIG. 9), and/or through manual control by a user who may make determinations regarding whether a given step, action, template, model, or set of curves has become sufficiently accurate for the evaluation of the signal(s) under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods are illustrated and described may be re-arranged, and/or two or more elements may occur simultaneously. The embodiments were chosen and described in order to best explain the principles of the invention and its practical applications, to thereby enable others skilled in the art to best utilize the invention and various embodiments with various modifications as are suited to the particular use contemplated.

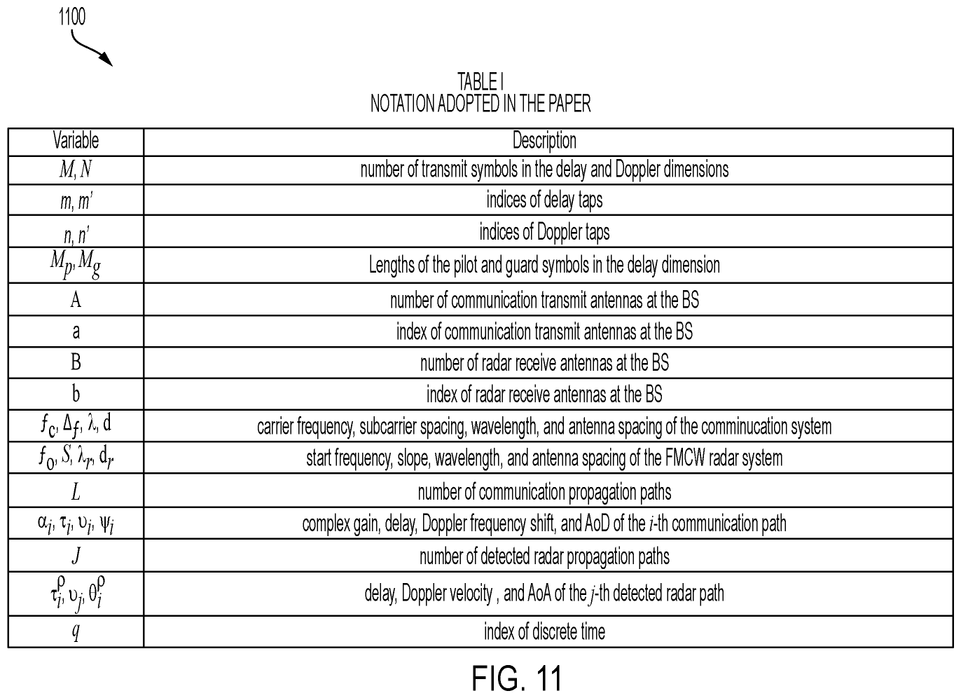

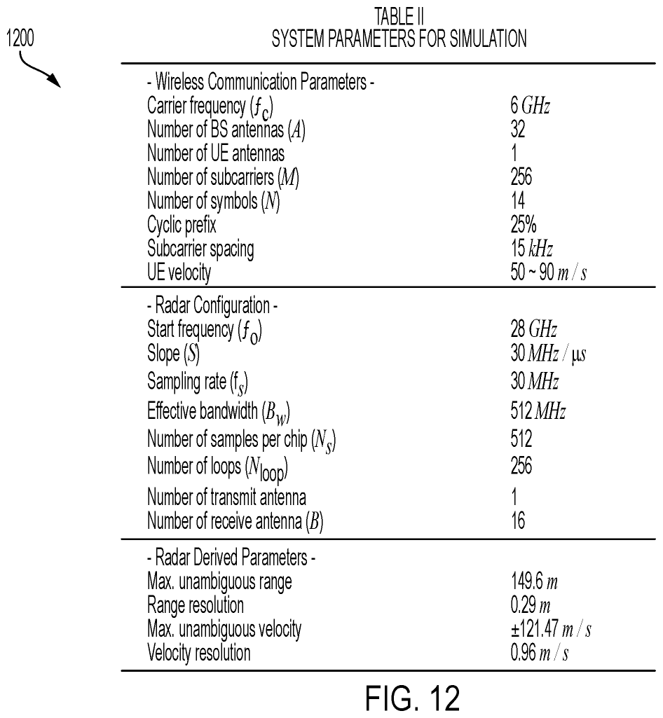

FIG. 11 shows Table 1 1100 that lists the notation used in this disclosure. FIG. 12 shows Table II 1200 that list the example system parameters used for the simulation described in this disclosure.

### VII. Conclusions

In summary, the downlink channel estimation problem for massive MIMO-OTFS systems is discussed and developed a novel approach that leverages the radar sensing information at the base station to aid the OTFS channel estimation task is provided.

This is particularly motivated by the integration of sensing and communication in future wireless systems and by the direct relationship between the delay-Doppler channel and the sensing information (such as location/velocity/direction) about the mobile user/scatterers in the environment. The delay-Doppler channel estimation problem is formulated as a sparse recovery problem and utilized radar sensing to aid the compressive sensing solution. Using accurate 3D ray tracing, an evaluation platform with co-existing communication and radar sensing data is constructed and used it to assess the performance of the disclosed solution. The results showed that the disclosed sensing-aided OTFS channel estimation approach consistently outperforms the conventional OMP in terms of both the channel estimation NMSE and the required pilot overhead, highlighting a promising approach for future OTFS massive MIMO systems.

What is claimed is:

1. A method comprising:
receiving one or more radar data frames from one or more antennas of a base station or a user equipment device in an environment;
processing the one or more radar data frames to identify one or more attributes of one or more static objects and/or one or more dynamic objects in the environment; and
estimating one or more channels, one or more attributes of the one or more channels, or both for the user equipment device and the base station based on the one or more attributes of the one or more static objects and the one or more dynamic objects.

2. The method of claim 1, wherein the one or more attributes of the one or more static objects and the one or more dynamic objects comprise angle of arrival (AoA), angle of departure (AoD), delay, and Doppler velocity and the one or more attributes of the one or more channels comprise a power gain, a complex gain, delay, angle of arrival, and angle of departure of the one or more channels.

3. The method of claim 1, wherein the processing the one or more radar data frames comprises removing radar signals corresponding to the one or more static objects to yield one or more decluttered radar data frames.

4. The method of claim 3, further comprising performing a first discrete Fourier transformation on the one or more decluttered radar data frames to extract range information corresponding to one or more moving objects in the one or more decluttered radar data frames.

5. The method of claim 4, further comprising performing a second discrete Fourier transformation on the one or more decluttered radar data frames to extract Doppler information corresponding to the one or more moving objects in the one or more decluttered radar data frames.

6. The method of claim 5, further comprising performing a third discrete Fourier transformation on the one or more decluttered radar data frames to extract angle information corresponding to the one or more moving objects in the one or more decluttered radar data frames.

7. The method of claim 6, further comprising generating a radar 3D-heatmap based on the range information, the Doppler information, and the angle information.

8. The method of claim 7, further comprising determining one or more peaks in the 3D-heatmap.

9. The method of claim 8, further comprising estimating a channel or channel attributes based on the one or more peaks in the 3D heatmap.

10. The method of claim 9, further comprising extracting one or more radar paths based on the one or more peaks that were determined.

11. A computer system comprising:
a hardware processor;
a non-volatile computer readable medium that stores instruction that when executed by the hardware processor perform a method comprising:
receiving one or more radar data frames from one or more antennas of a base station or a user equipment device in an environment;
processing the one or more radar data frames to identify one or more attributes of one or more static objects and one or more dynamic objects in the environment; and
estimating one or more channels, one or more attributes of the one or more channels, or both for the user equipment device and the base station based on the one or more attributes of the one or more static objects and the one or more dynamic objects.

12. The computer system of claim 1, wherein the one or more attributes of the one or more static objects and the one or more dynamic objects comprise angle of arrival (AoA), angle of departure (AoD), delay, and Doppler velocity and the one or more attributes of the one or more channels comprise a power gain, a complex gain, delay, angle of arrival, and angle of departure of the one or more channels.

13. The computer system of claim 11, wherein the processing the one or more radar data frames comprises removing radar signals corresponding to the one or more static objects to yield one or more decluttered radar data frames.

14. The computer system of claim 13, wherein the method further comprises performing a first discrete Fourier transformation on the one or more decluttered radar data frames to extract range information corresponding to one or more moving objects in the one or more decluttered radar data frames.

15. The computer system of claim 14, wherein the method further comprises performing a second discrete Fourier transformation on the one or more decluttered radar data frames to extract Doppler information corresponding to the one or more moving objects in the one or more decluttered radar data frames.

16. The computer system of claim 15, wherein the method further comprises performing a third discrete Fourier transformation on the one or more decluttered radar data frames to extract angle information corresponding to the one or more moving objects in the one or more decluttered radar data frames.

17. The computer system of claim 16, wherein the method further comprises generating a radar 3D-heatmap based on the range information, the Doppler information, and the angle information.

18. The computer system of claim 17, wherein the method further comprises determining one or more peaks in the 3D-heatmap.

19. The computer system of claim 18, wherein the method further comprises estimating a channel or channel attribute based on the one or more peaks in the 3D heatmap.

20. The computer system of claim 19, wherein the method further comprises extracting one or more radar paths based on the one or more peaks that were determined.
